(19) United States
(12) Patent Application Publication
(10) Pub. No.: US 2021/0117858 A1
(43) Pub. Date: Apr. 22, 2021

(54) INFORMATION PROCESSING DEVICE, INFORMATION PROCESSING METHOD, AND STORAGE MEDIUM

(71) Applicant: NEC CORPORATION, Tokyo (JP)

(72) Inventor: Yasuhiro AJIRO, Tokyo (JP)

(73) Assignee: NEC Corporation, Tokyo (JP)

(21) Appl. No.: 16/981,530

(22) PCT Filed: Mar. 19, 2018
(86) PCT No.: PCT/JP2018/010801

§ 371 Date: Sep. 16, 2020

(51) Int. Cl. G06N 20/00; G06F 16/28

(52) U.S. Cl. CPC G06N 20/00; G06F 16/285

(57) ABSTRACT

Provided is an information processing device including: a data acquisition unit that acquires, from a target system, learning data used in learning of a model used for anomaly detection and inspection data to be used for inspection of the model in the target system; and a determination unit that, based on a deviation degree between a data distribution of the learning data and a data distribution of the inspection data, determines whether or not relearning of the model is required.

### TECHNICAL FIELD

The present invention relates to an information processing device, an information processing method, and a storage medium.

### BACKGROUND ART

Techniques of learning a model based on learning data acquired from a system of an inspection target and using the model to detect abnormal data from inspection data are known. Patent literature 1 discloses an anomaly detection system that models learning data by using a subspace method and detects anomaly candidates based on a distance between data in a subspace.

### CITATION LIST

### Patent Literature

PTL 1: Japanese Patent Application Laid-open No. 2013-218725

### SUMMARY OF INVENTION

In the technique disclosed in Patent Literature 1, when the data trend changes between learning data and inspection data, erroneous detection of normal data or overlook of abnormal data may occur. To address such a case, a method of periodically relearning a model by using the latest data may be considered. However, since such a method involves inspection of validity of the model by an expert, there is a problem of increased cost.

The present invention has been made in view of the problem described above and intends to provide an information processing device, an information processing method, and a storage medium that can promptly detect a change in a data trend and perform relearning of a model at a suitable timing.

According to one example aspect of the present invention, provided is an information processing device including: a data acquisition unit that acquires, from a target system, learning data used in learning of a model to be used for anomaly detection and inspection data used for inspection of the model in the target system; and a determination unit that, based on a deviation degree between a data distribution of the learning data and a data distribution of the inspection data, determines whether or not relearning of the model is required.

According to the present invention, an information processing device, an information processing method, and a storage medium that can promptly detect a change in a data trend and perform relearning of a model at a suitable timing can be provided.

### BRIEF DESCRIPTION OF DRAWINGS

FIG. 1 is a schematic diagram illustrating a relationship between an information processing device and a target system according to a first example embodiment of the present invention.

FIG. 2 is a block diagram illustrating a function configuration of the information processing device according to the first example embodiment of the present invention.

FIG. 3 is a table illustrating an example of log data acquired from a target system in the first example embodiment of the present invention.

FIG. 4 is a schematic diagram illustrating an example of clustering in the first example embodiment of the present invention.

FIG. 5 is a schematic diagram illustrating an example of cluster determination in the first example embodiment of the present invention.

FIG. 6 is a table illustrating an example of an expected frequency distribution in the first example embodiment of the present invention.

FIG. 7 is a table illustrating an example of an observed frequency distribution in the first example embodiment of the present invention.

FIG. 8 is a block diagram illustrating an example of a hardware configuration of the information processing device according to the first example embodiment of the present invention.

FIG. 9 is a flowchart illustrating an example of a learning process of a model of the information processing device according to the first example embodiment of the present invention.

FIG. 10 is a flowchart illustrating an example of an inspection process of a model of the information processing device according to the first example embodiment of the present invention.

FIG. 11 is a block diagram illustrating a function configuration of an information processing device according to a second example embodiment of the present invention.

FIG. 12 is a schematic diagram illustrating a determination method of a change in a data trend in the second example embodiment of the present invention.

FIG. 13 is a flowchart illustrating an example of a learning process of a model in the information processing device according to the second example embodiment of the present invention.

FIG. 14 is a flowchart illustrating an example of an inspection process of a model in the information processing device according to the second example embodiment of the present invention.

FIG. 15 is a block diagram illustrating a function configuration of an information processing device according to a third example embodiment of the present invention.

### DESCRIPTION OF EMBODIMENTS

Example embodiments of the present invention will be described below with reference to the drawings. Note that, throughout the drawings described below, components having the same function or corresponding functions are labeled with the same reference, and the repeated description thereof may be omitted.

### First Example Embodiment

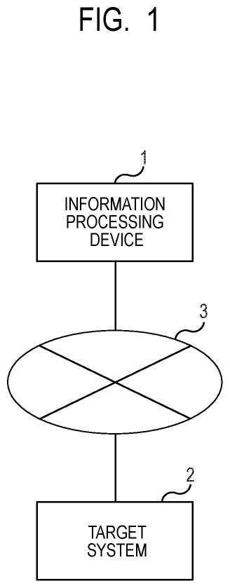

An information processing device 1 and an information processing method according to a first example embodiment of the present invention will be described with reference to FIG. 1 to FIG. 10.

FIG. 1 is a schematic diagram illustrating the relationship of the information processing device 1 and a target system 2 according to the present example embodiment. As illustrated in FIG. 1, the target system 2 is communicably connected to the information processing device 1 via a network 3. The target system 2 generates and outputs data to be processed in the information processing device 1. For example, the network 3 is a local area network (LAN) or a wide area network (WAN), however, the type thereof is not limited. The network 3 may be a wired network or may be a wireless network. Note that the type of the data to be processed is not limited but is log data as an example in the following description.

The target system 2 is not limited to a particular system. The target system 2 is an information technology (IT) system, for example. The IT system is formed of a server, a client terminal, a network device, another device such as an information device, and various software operating on the device. Note that the target system 2 of the present example embodiment is a mail system that manages transmission and reception of mails. Further, the number of target systems 2 is not limited to one and may be plural.

Data generated in response to transmission or reception of a mail in the target system 2 is input to the information processing device 1 according to the present example embodiment via the network 3. The form by which data is input from the target system 2 to the information processing device 1 is not particularly limited. Such a form of input can be selected as appropriate in accordance with the configuration of the target system 2 or the like.

For example, a notification agent in the target system 2 transmits log data generated in the target system 2 to the information processing device 1 and thereby is able to input log data to the information processing device 1. The protocol for transmission of log data is not particularly limited. The protocol can be selected as appropriate in accordance with the configuration of the system that transmits log data or the like. For example, syslog protocol, File Transfer Protocol (FTP), File Transfer Protocol over Transport Layer Security (TLS)/Secure Sockets Layer (SSL) (FTPS), or Secure Shell (SSH) File Transfer Protocol (SFTP) may be used as a protocol. Further, the target system 2 shares generated log data with the information processing device 1 and thereby can input log data to the information processing device 1. A scheme for file sharing to share log data is not particularly limited. The method for file sharing is selected as appropriate in accordance with the configuration of a system that generates log data or the like. For example, file sharing by Server Message Block (SMB) or Common Internet File System (CIFS) expanded from SMB can be used.

Note that the information processing device 1 according to the present example embodiment is not necessarily required to be communicably connected to the target system 2 via the network 3. For example, the information processing device 1 may be communicably connected via the network 3 to a log collection system (not illustrated) that collects log data from the target system 2. In such a case, the log data generated by the target system 2 is once collected by a log collection system. The log data is then input to the information processing device 1 from the log collection system via the network 3. Further, the information processing device 1 according to the present example embodiment can also acquire log data from a storage medium in which log data generated by the target system 2 is stored. In such a case, the target system 2 is not required to be connected to the information processing device 1 via the network 3.

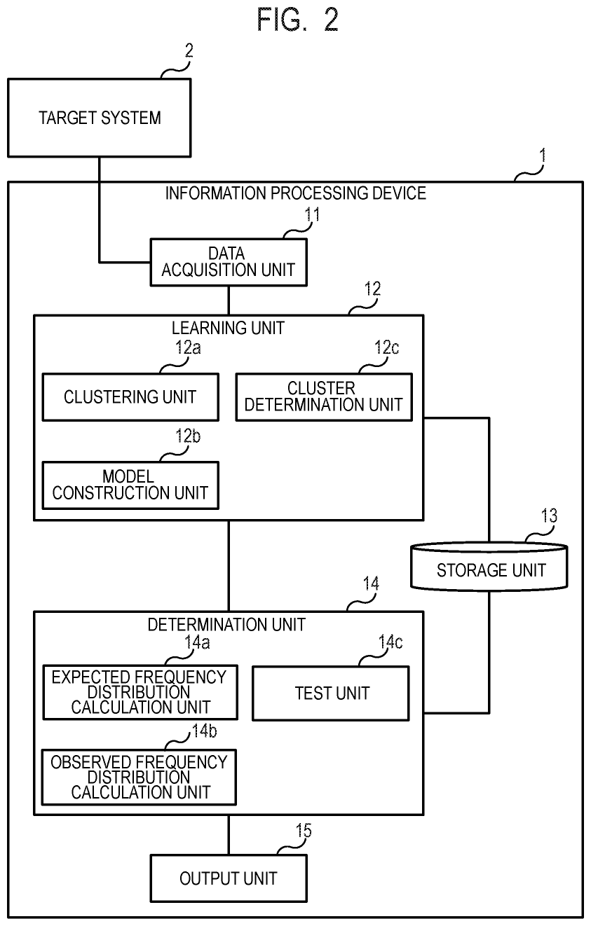

The specific configuration of the information processing device 1 according to the present example embodiment will be further described below with reference to FIG. 2 to FIG. 8. FIG. 2 is a block diagram illustrating a function configuration of the information processing device 1 according to the present example embodiment.

As illustrated in FIG. 2, the information processing device 1 has a data acquisition unit 11, a learning unit 12, a storage unit 13, a determination unit 14, and an output unit 15. The data acquisition unit 11 acquires, from the target system 2, learning data used in learning of a model used for anomaly detection and inspection data to be used for inspection of a model in the target system 2. The learning data and the inspection data are data having a common data item, which are data included in different populations, respectively. The population is defined arbitrarily in accordance with a period in which log data is generated, a section and a place in which log data is generated, or the like, for example. The log data to be processed in the information processing device 1 according to the present example embodiment are those generated and output regularly or irregularly by the target system 2 or a component included therein.

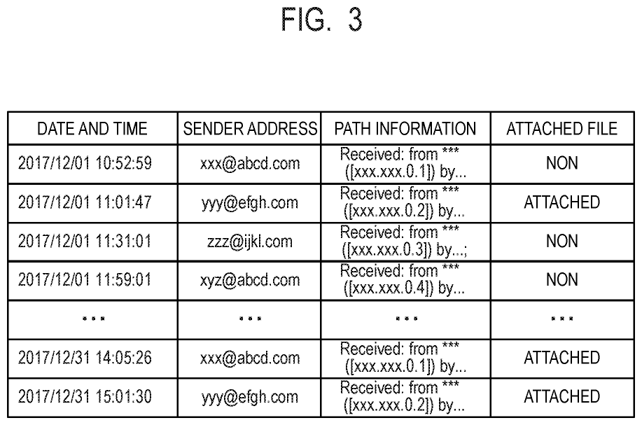

FIG. 3 is a table illustrating an example of log data acquired from the target system 2 in the present example embodiment. Herein, a mail reception history is illustrated as log data. The mail reception history includes reception data and time, a sender address, path information, with or without an attached file as parameters. For example, in the case of the log data of reception date and time “2017/12/01 10:52:59”, it is indicated that a mail received from a sender address “xxx@abcd.com” reached the target system 2 (mail server) via a path on a network indicated by the path information “Received: from *** ([xxx.xxx.0.1]) by . . . ” and the mail had no attached file. Note that the mail reception history illustrated in FIG. 3 is a mere example and may further include a parameter other than the above. Further, although only the mail reception history related to one of the plurality of users is illustrated as an example in FIG. 3, it is assumed that similar mail reception histories are stored for other users.

Further, it is assumed that learning data and inspection data in the present example embodiment have been generated in different periods, respectively. For example, the learning data is a mail reception history within the past one year, and the inspection data is a mail reception history on the day of inspection. Accordingly, it is possible to determine whether or not the data trend of learning data on which a model is based matches the data trend of inspection data of a different period.

Further, inspection data in the present example embodiment is generated in a later period than learning data. The information processing device 1 can detect a data trend in a past certain period by analyzing learning data. In contrast, the information processing device 1 can detect a data trend newer than that at the time of generation of learning data by analyzing inspection data. Note that an extraction period of inspection data (hereafter, referred to as an inspection period) from the target system 2 may be partially or fully included in a learning data extraction period (hereafter, referred to as a learning period). For example, a learning period is set to a half year from January to June, 2017, and an inspection period is set to one month of June, 2017.

The learning unit 12 learns a model used for anomaly detection in the target system 2 based on learning data. As illustrated in FIG. 2, the learning unit 12 includes a clustering unit 12a, a model construction unit 12b, and a cluster determination unit 12c.

The clustering unit 12a performs clustering on learning data input from the data acquisition unit 11. The clustering unit 12a stores a clustering result in the storage unit 13. The clustering result in the present example embodiment is a data set of a combination of a two-dimensional vector made of two index values indicating a feature amount of log data and a cluster ID of a cluster to which log data is classified.

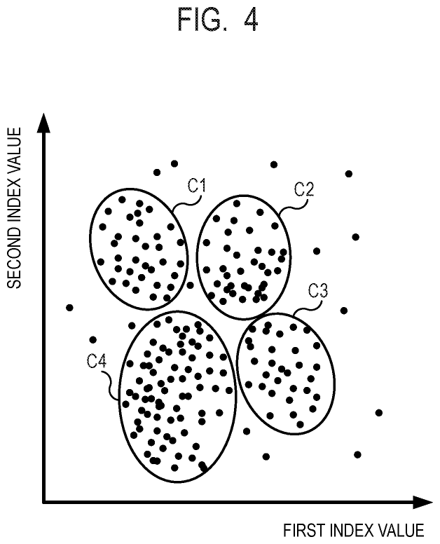

FIG. 4 is a schematic diagram illustrating an example of clustering in the present example embodiment. A two-dimensional plane (subspace) made of a first index value (horizontal axis) and a second index value (vertical axis) is illustrated here. A plurality of points representing log data (marks of black circles in FIG. 4) are plotted in the two-dimensional plane. For example, out of the parameters illustrated in FIG. 3, two parameters of a sender address and path information are used as index values. A similarity between data is higher for a shorter distance between data. Contrarily, a similarity between data is lower for a longer distance between data. In FIG. 4, ellipses C1 to C4 illustrate boundaries of log data groups (clusters) having a common cluster ID (label). Further, log data which is not included in any of the ellipses C1 to C4 corresponds to data considered as an anomaly candidate (hereafter, referred to as abnormal data). Note that, as a clustering scheme, a technique such as density-based spatial clustering of applications with noise (DBSCAN), a k-means method, or the like can be used, for example.

The model construction unit 12b constructs a model used for anomaly detection for determining a cluster to which unknown input data belongs based on a result of clustering in the clustering unit 12a. The model construction unit 12b then stores the constructed model in the storage unit 13. As a scheme for cluster determination (classification), a technique such as a k-nearest neighbor algorithm (k-NN), Support Vector Machine (SVM), or the like can be used, for example.

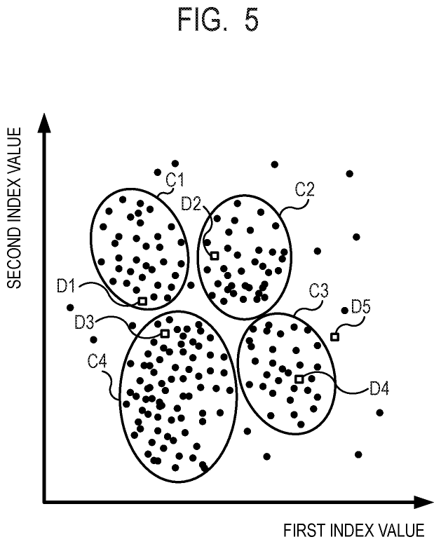

The cluster determination unit 12c determines a cluster to which inspection data input from the data acquisition unit 11 belongs based on a model stored in the storage unit 13. FIG. 5 is a schematic diagram illustrating an example of a cluster determination in the present example embodiment. Herein, a case where inspection data D1 to D5 (marks of squares in FIG. 5) are input to the models corresponding to the boundaries of the ellipses C1 to C4, respectively, is illustrated. For example, the cluster determination unit 12c determines that the inspection data D1 to D4 belong to the clusters of the ellipses C1 to C4, respectively. Since the inspection data D5 is not included in any of the regions of the ellipses C1 to C4, the cluster determination unit 12c determines that the inspection data D5 is abnormal data.

The determination unit 14 determines whether or not relearning of a model is required based on a deviation degree between a data distribution of learning data and a data distribution of inspection data. The deviation degree between two data distributions indicates a degree of a change in the data trend between learning data and inspection data. When there is a change in the data trend, the determination unit 14 determines that relearning of a model is required. Further, as illustrated in FIG. 2, the determination unit 14 includes an expected frequency distribution calculation unit 14a, an observed frequency distribution calculation unit 14b, and a test unit 14c.

The expected frequency distribution calculation unit (first calculation unit) 14a calculates an expected frequency distribution based on a result of clustering in the clustering unit 12a. The expected frequency distribution represents a relationship between a cluster to which learning data belongs and a data quantity on a cluster basis.

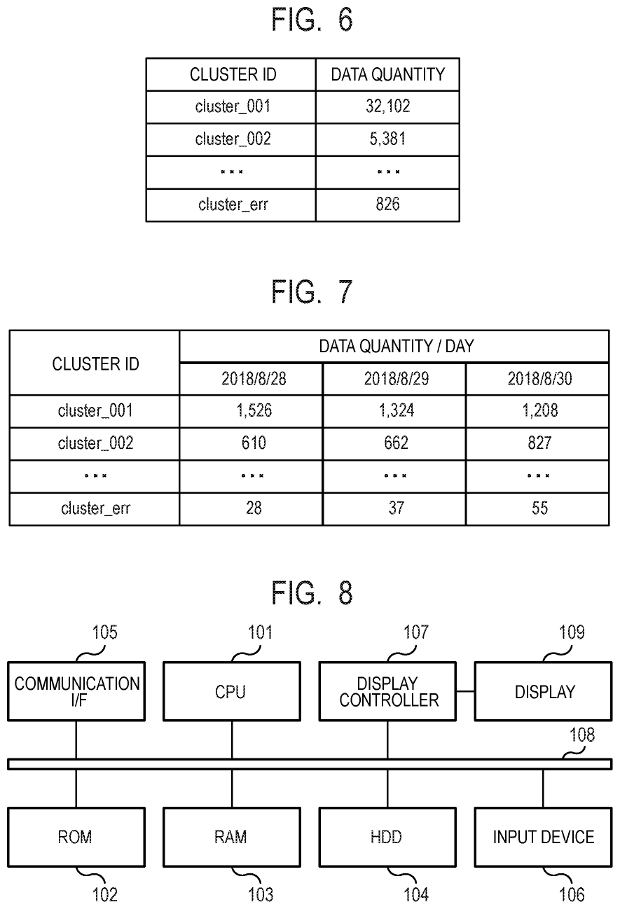

FIG. 6 is a table illustrating an example of an expected frequency distribution in the present example embodiment. Herein, the expected frequency distribution is represented by a combination of a cluster ID and a data quantity. For example, the data quantity of learning data belonging to the cluster of the cluster ID “cluster_001” is “32,102”. Further, the cluster ID “cluster_err” is an ID for a set that aggregates clusters each having data quantity less than a certain quantity. That is, the data quantity of the cluster ID “cluster_err” indicates the quantity of learning data considered as abnormal data (outlier).

The observed frequency distribution calculation unit (second calculation unit) 14b calculates an observed frequency distribution based on a result of determination in the cluster determination unit 12c. The observed frequency distribution represents a relationship between a cluster to which inspection data belongs and a data quantity on a cluster basis.

FIG. 7 is a table illustrating an example of an observed frequency distribution in the present example embodiment. Herein, the observed frequency distribution is a data set of a combination of a cluster ID and a data quantity per day. For example, in a case of the inspection data of Aug. 28, 2018, the data quantity of inspection data belonging to a cluster of the cluster ID “cluster_001” is “1,526”. Further, the inspection data quantity corresponding to the cluster ID “cluster_err” is “28” for the case of inspection data of Aug. 28, 2018 and “55” for the case of inspection data of Aug. 30, 2018.

The test unit 14c tests whether or not an error (deviation degree) of an observed frequency distribution to an expected frequency distribution exceeds a predetermined significance level value. For example, 0.05 is used as the significance level value.

The output unit 15 outputs a determination result in the determination unit 14. The output unit 15 of the present example embodiment is formed of a display 109. Note that a configuration of transmitting data of a process result to a device outside the information processing device 1 may be employed instead of display on the display 109. Further, the output unit 15 may be formed of an output device such as a printer (not illustrated). Such another device that has received data may perform processing using the data as required or may perform display. Furthermore, the information processing device 1 may be configured to store a process result in a storage device and transmit the process result to another device in response to a request from another device.

The information processing device 1 described above is formed of a computer device, for example. FIG. 8 is a block diagram illustrating an example of a hardware configuration of the information processing device 1 according to the present example embodiment. Note that the information processing device 1 may be formed of a single device. Alternatively, the information processing device 1 may be formed of two or more physically separated devices connected by a wire or wirelessly.

As illustrated in FIG. 8, the information processing device 1 has a central processing unit (CPU) 101, a read only memory (ROM) 102, a random access memory (RAM) 103, a hard disk drive (HDD) 104, a communication interface (I/F) 105, an input device 106, and a display controller 107. The CPU 101, the ROM 102, the RAM 103, the HDD 104, the communication I/F 105, the input device 106, and the display controller 107 are connected to a common bus line 108.

The CPU 101 controls the operation of the entire information processing device 1. Further, the CPU 101 executes a program that implements functions of respective components of the data acquisition unit 11, the learning unit 12, the determination unit 14, and the output unit 15. The CPU 101 loads and executes a program stored in the HDD 104 or the like to the RAM 103 and thereby implements the function of each component.

The ROM 102 stores a program such as a boot program. The RAM 103 is used as a working area when the CPU 101 executes a program.

Further, the HDD 104 is a storage device that stores a process result in the information processing device 1 and various programs executed by the CPU 101. The storage device is not limited to the HDD 104 as long as it is nonvolatile. The storage device may be a flash memory or the like, for example. In the present example embodiment, the HDD 104, the ROM 102, and the RAM 103 implement the function as the storage unit 13.

The communication I/F 105 controls data communication with the target system 2 connected to the network 3. The communication I/F 105 implements the function of the data acquisition unit 11 along with the CPU 101.

The input device 106 is a human interface such as a keyboard, a mouse, or the like, for example. Further, the input device 106 may be a touch panel embedded in the display 109. The user of the information processing device 1 may perform entry of settings of the information processing device 1, entry of an execution instruction of a process, or the like via the input device 106.

The display 109 is connected to the display controller 107. The display controller 107 functions as the output unit 15 along with the CPU 101. The display controller 107 causes the display 109 to display an image based on the output data. Note that the hardware configuration of the information processing device 1 is not limited to the configuration described above.

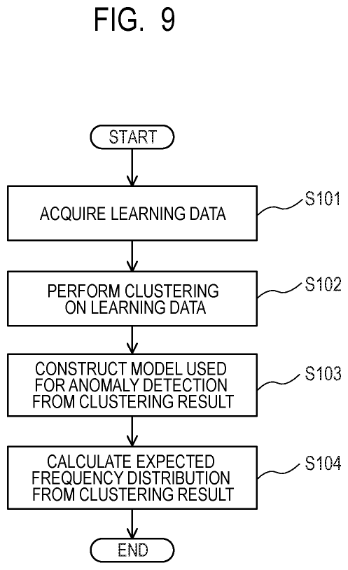

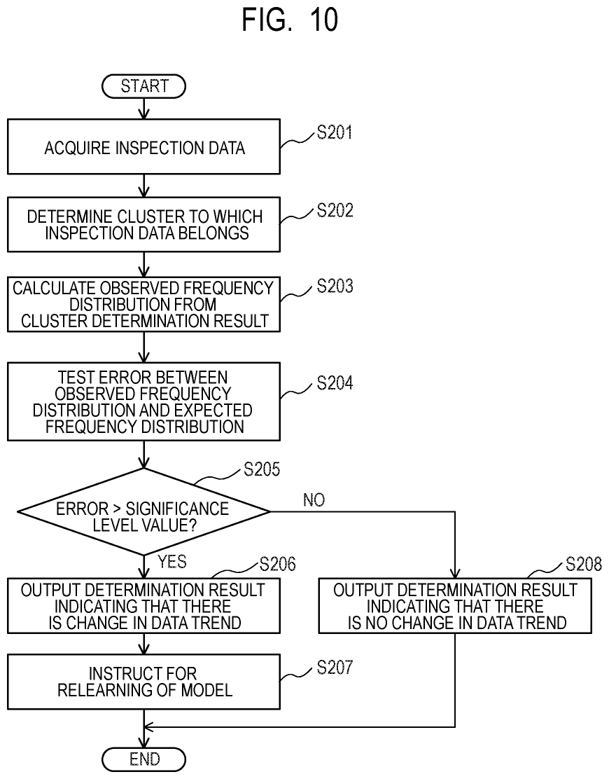

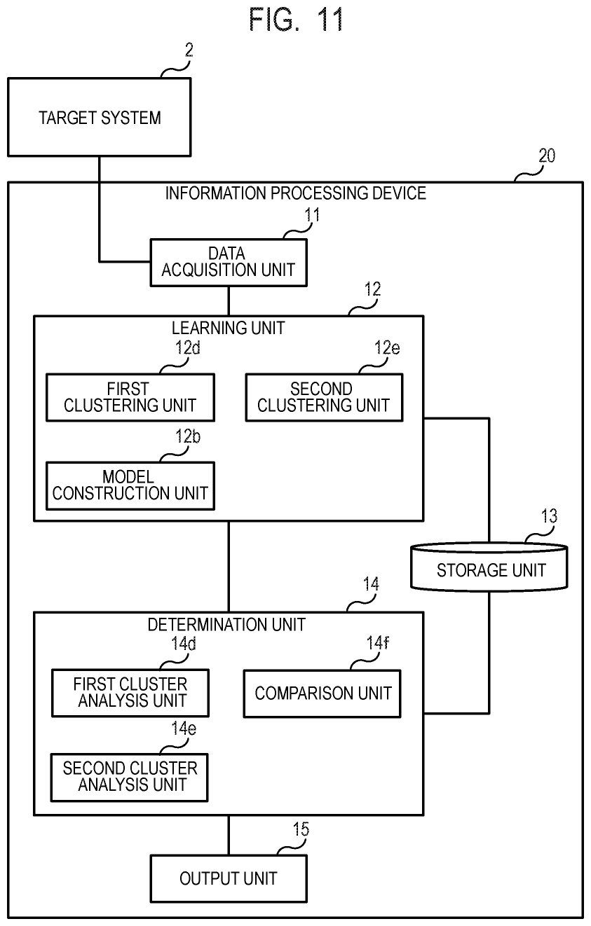

The operation of the information processing device 1 will be described below in detail with reference to FIG. 9 and FIG. 10. Note that, although data analysis on a mail reception history described above will be described as an example in the following description, the present invention is not limited thereto.

FIG. 9 is a flowchart illustrating an example of a learning process of the information processing device 1 according to the present example embodiment. This process is started when an execution request of a learning process for a model is input by the user of the information processing device 1 together with a learning data extraction period (learning period), for example.

First, the data acquisition unit 11 acquires log data included in a learning period as learning data from the target system 2 (step S101) and outputs the learning data to the clustering unit 12a.

Next, the clustering unit 12a performs clustering on the learning data input from the data acquisition unit 11 in accordance with a predetermined algorithm (step S102). At this time, the clustering unit 12a stores a clustering result in the storage unit 13.

Next, the model construction unit 12b constructs a model used for anomaly detection from a clustering result in the clustering unit 12a (step S103). At this time, the model construction unit 12b stores the constructed model in the storage unit 13.

The expected frequency distribution calculation unit 14a then calculates an expected frequency distribution from the clustering result (step S104). At this time, the expected frequency distribution calculation unit 14a stores the calculated expected frequency distribution in the storage unit 13. Note that the process of step S104 may be performed in the flowchart of FIG. 10 described later.

FIG. 10 is a flowchart illustrating an example of an inspection process of a model of the information processing device 1 according to the present example embodiment. This process is started when an execution request of an inspection process for a model is input by the user of the information processing device 1 together with an inspection data extraction period (inspection period), for example.

First, the data acquisition unit 11 acquires log data included in the inspection period from the target system 2 as inspection data (step S201) and outputs the inspection data to the cluster determination unit 12c.

Next, the cluster determination unit 12c determines a cluster to which the inspection data input from the data acquisition unit 11 belongs by using a model (step S202). At this time, the cluster determination unit 12c stores the cluster determination result in the storage unit 13.

Next, the observed frequency distribution calculation unit 14b calculates an observed frequency distribution from the cluster determination result (step S203) and outputs the observed frequency distribution to the test unit 14c.

Next, the test unit 14c tests an error between the expected frequency distribution read from the storage unit 13 and the observed frequency distribution input from the observed frequency distribution calculation unit 14b (step S204). As a test method, a technique of a chi-square test or the like can be used.

Next, the test unit 14c determines whether or not the error exceeds a predetermined significance level value (step S205). Here, if the test unit 14c determines that the error exceeds the predetermined significance level value (step S205, YES), the test unit 14c proceeds to the process of step S206. In contrast, if the test unit 14c determines that the error does not exceed the predetermined significance level value (step S205, NO), the test unit 14c proceeds to the process of step S208.

Next, the test unit 14c causes the output unit 15 to output a determination result indicating that there is a change in the data trend (step S206) and instructs the learning unit 12 to relearn a model used for anomaly detection (step S207). At this time, the learning unit 12 performs relearning of a model based on the learning data including inspection data, for example, and stores a new model obtained by the relearning in the storage unit 13. Note that a timing of performing relearning or learning data to be used are not limited to the above.

In step S208, the test unit 14c causes the output unit 15 to output a determination result indicating that there is no change in the data trend. That is, it is determined that the existing model sufficiently supports the inspection data and there is no need for relearning of the model.

As described above, according to the information processing device 1 of the present example embodiment, it is possible to promptly detect a change in the data trend and perform relearning of a model at a suitable timing. For example, when the target system 2 is a mail system, it is possible to propose relearning of a model to the user at an early timing by detecting a change in the data trend of log data. As a result, it is possible to accurately detect an unauthorized mail such as a spam mail using the relearning model. Further, by performing relearning of a model as required, it is possible to suppress cost required for learning of a model.

### Second Example Embodiment

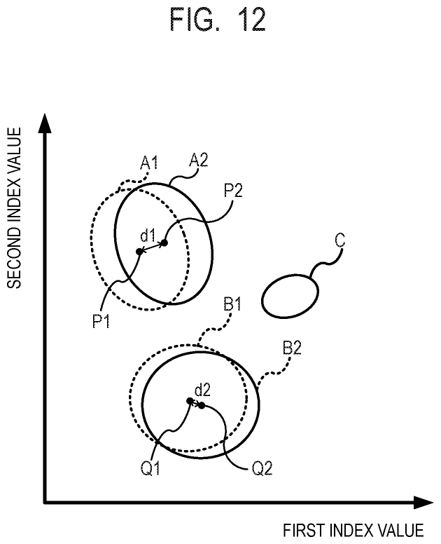

An information processing device 20 according to a second example embodiment of the present invention will be described with reference to FIG. 11 to FIG. 14. Note that, in the following description, description of the same features as those of the first example embodiment will be omitted or simplified.

FIG. 11 is a block diagram illustrating a function configuration of the information processing device 20 according to the present example embodiment. As illustrated in FIG. 11, the learning unit 12 of the present example embodiment has a first clustering unit 12d and a second clustering unit 12e. The first clustering unit 12d corresponds to the clustering unit 12a of the first example embodiment and performs clustering on learning data. On the other hand, the second clustering unit 12e performs clustering on inspection data. For example, the second clustering unit 12e determines a cluster to which inspection data belongs in accordance with a model constructed from learning data and then performs clustering on the inspection data based on the determination result. In such a case, it is possible to complete clustering of inspection data in a short time. Note that the same scheme as used in the clustering unit 12a of the first example embodiment can also be used.

The determination unit 14 of the present example embodiment compares a result of clustering on learning data with a result of clustering on inspection data and thereby determines whether or not relearning of a model is required. The determination unit 14 of the present example embodiment does not have the expected frequency distribution calculation unit 14a and the observed frequency distribution calculation unit 14b of the first example embodiment. Instead, the determination unit 14 has a first cluster analysis unit 14d, a second cluster analysis unit 14e, and a comparison unit 14f.

The first cluster analysis unit 14d analyzes a clustering result of learning data in the first clustering unit 12d and thereby creates first cluster analysis information. On the other hand, the second cluster analysis unit 14e analyzes a clustering result of inspection data in the second clustering unit 12e and thereby creates second cluster analysis information. A specific example of cluster analysis information may be centroid coordinates of each cluster, a data quantity of data belonging to each cluster, the total number of clusters, the number of outliers, or the like.

The comparison unit 14f compares the first cluster analysis information with the second cluster analysis information and thereby determines whether or not there is a change in the data trend (whether or not relearning of a mode is required). Specific examples of the determination method may be methods of (1) to (5) below.

(1) Comparing the number of clusters generated by clustering on learning data with the number of clusters generated by clustering on inspection data. If there is an increase or a decrease in the number of clusters, the comparison unit 14f determines that there is a change in the data trend.

(2) Comparing the centroid coordinates of clusters in a correspondence relationship between learning data and inspection data among clusters generated by clustering. If a variation range of the centroid coordinates of clusters in a subspace exceeds a predetermined threshold, the comparison unit 14f determines that there is a change in the data trend.

(3) Comparing the data quantity of abnormal data of learning data with the data quantity of abnormal data of inspection data, that is, the quantity of data not belonging to any of the data. Then, if the increase rate of the detected quantity of abnormal data during the inspection exceeds a predetermined threshold, the comparison unit 14f determines that there is a change in the data trend. Whether or not certain data is abnormal data can be determined in accordance with whether or not a distance to data belonging to an existing cluster is longer than a certain distance.

(4) Comparing changes in the quantity of data belonging to a certain cluster. For example, if the data quantity per day of the data belonging to a cluster A is significantly different between learning data and inspection data, the comparison unit 14f determines that there is a change in the data trend.

(5) If the numbers of clusters are the same in the method (1) described above, using a new cluster group (a clustering result of inspection data) to determine the past data (learning data during learning of a model) and comparing the detected quantity of abnormal data with that when determined in the past cluster.

FIG. 12 is a schematic diagram illustrating a determination method of a change in the data trend in the present example embodiment. Herein, ellipses A1 and B1 with dashed lines represent boundaries of clusters of learning data. Further, ellipses A2, B2, and C with solid lines represent boundaries of clusters of inspection data. Further, A1 and A2 are clusters in a correspondence relationship having a common cluster ID, for example. Similarly, B1 and B2 are also clusters in a correspondence relationship. Points P1, P2, Q1, and Q2 represent positions of the centroid coordinates of the clusters related to ellipses A1, A2, B1, and B2, respectively. A variation range of the centroid coordinates between the clusters of A1 and A2, that is, the distance between the point P1 and the point P2 is d1. Similarly, a variation range of the centroid coordinates between the clusters of B1 and B2, that is, the distance between the point Q1 and the point Q2 is d2. In such a case, if one or both of the distances (variation ranges) d1 and d2 exceed a predetermined threshold, the determination unit 14 can determine that there is a change in the data trend.

On the other hand, a cluster related to the ellipse C is newly generated by clustering of inspection data. In such a way, even when the number of clusters increases, the determination unit 14 can determine that there is a change in the data trend. Note that the same applies to a case where the number of clusters decreases.

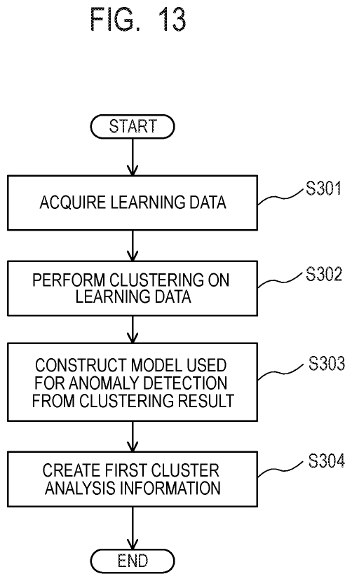

FIG. 13 is a flowchart illustrating an example of a learning process of a model of the information processing device 20 according to the present example embodiment. This process is started when an execution request of a learning process for a model is input by the user of the information processing device 1 together with a log data learning period, for example.

First, the data acquisition unit 11 acquires log data included in the learning period from the target system 2 as learning data (step S301) and outputs the learning data to the clustering unit 12a.

Next, the first clustering unit 12d performs clustering learning data input from the data acquisition unit 11 in accordance with a predetermined algorithm (step S302). At this time, the first clustering unit 12d stores the clustering result in the storage unit 13.

Next, the model construction unit 12b constructs a model used for anomaly detection from the clustering result in the first clustering unit 12d (step S303). At this time, the model construction unit 12b stores the constructed model in the storage unit 13.

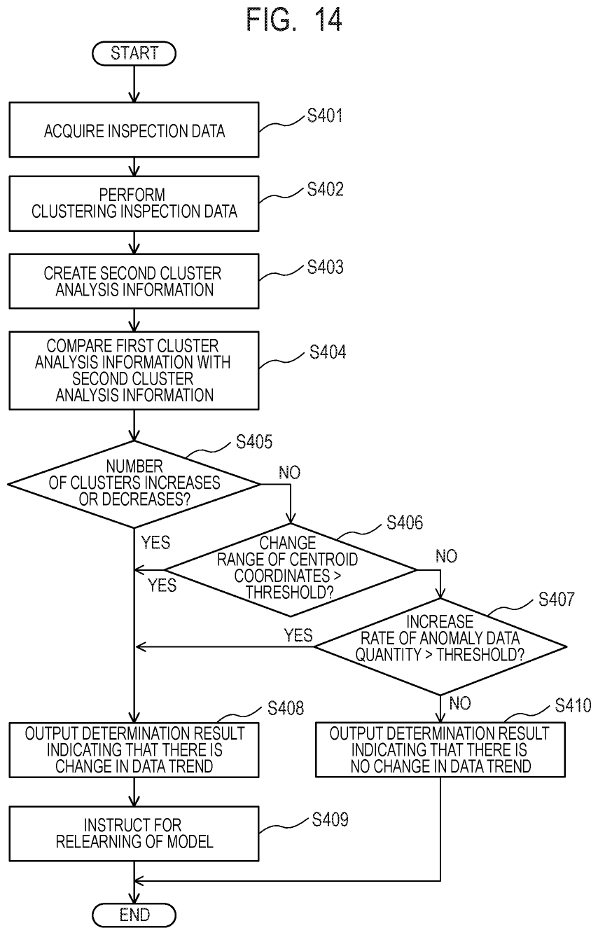

The first cluster analysis unit 14d then analyzes the clustering result and thereby creates first cluster analysis information (step S304). At this time, the first cluster analysis unit 14d stores the created first cluster analysis information in the storage unit 13. Note that the process of step S304 may be performed in the flowchart of FIG. 14 described later.

FIG. 14 is a flowchart illustrating an example of an inspection process of the information processing device 20 according to the present example embodiment. This process is started when an execution request of an inspection process for a model is input by the user of the information processing device 1, for example.

First, the data acquisition unit 11 acquires log data included in the inspection period from the target system 2 as inspection data (step S401) and outputs the inspection data to the cluster determination unit 12c.

Next, the second clustering unit 12e performs clustering on the inspection data input from the data acquisition unit 11 (step S402). At this time, the second clustering unit 12e stores the clustering result in the storage unit 13.

Next, the second cluster analysis unit 14e analyzes a clustering result in the second clustering unit 12e and thereby creates second cluster analysis information (step S403). At this time, the second cluster analysis unit 14e stores the created second cluster analysis information in the storage unit 13.

Next, the comparison unit 14f compares the first cluster analysis information during the learning with the second cluster information during the inspection (step S404) and determines whether or not there is an increase or a decrease in the number of clusters (step S405). Herein, if the comparison unit 14f determines that there is an increase or a decrease in the number of clusters (step S405, YES), the comparison unit 14f proceeds to the process of step S408. In contrast, if the comparison unit 14f determines that there is neither increase nor decrease in the number of clusters (step S405, NO), the comparison unit 14f proceeds to the process of step S406.

In step S406, the comparison unit 14f determines whether or not the variation range of the centroid coordinates between associated clusters exceeds a predetermined threshold. Herein, if the comparison unit 14f determines that the variation range of the centroid coordinates between associated clusters exceeds a predetermined threshold (step S406, YES), the comparison unit 14f proceeds to the process of step S408. In contrast, if the comparison unit 14f determines that the variation range of the centroid coordinates does not exceed a predetermined threshold (step S406, NO), the comparison unit 14f proceeds to the process of step S407.

In step S407, the comparison unit 14f determines whether or not the increase rate of the detected quantity of abnormal data during the inspection exceeds a predetermined threshold with respect to the time of learning as a reference. Herein, if the comparison unit 14f determines that the increase rate of the detected quantity exceeds a predetermined threshold (step S407, YES), the comparison unit 14f proceeds to the process of step S408. In contrast, if the comparison unit 14f determines that the increase rate of the detected quantity does not exceed a predetermined threshold (step S407, NO), the comparison unit 14f proceeds to the process of step S410.

Next, the determination unit 14 causes the output unit 15 to output the determination result indicating that there is a change in the data trend (step S408) and instructs the learning unit 12 to relearn a model used for anomaly detection (step S409). At this time, the learning unit 12 performs relearning of the model based on another learning data including inspection data. The learning unit 12 then stores a new model obtained by the relearning in the storage unit 13. Note that a timing of performing relearning or learning data to be used are not limited to the above.

In step S410, the determination unit 14 causes the output unit 15 to output a determination result indicating that there is no change in the data trend. That is, it is determined that the existing model sufficiently supports the inspection data and there is no need for relearning of the model.

As described above, according to the information processing device 20 of the present example embodiment, it is possible to promptly detect a change in the data trend and perform relearning of a model at a suitable timing in the same manner as in the first example embodiment. Since a clustering result during learning and a clustering result during inspection of a model are compared, a change in the data trend can be detected based on more various conditions than in the case of the first example embodiment.

### Third Example Embodiment

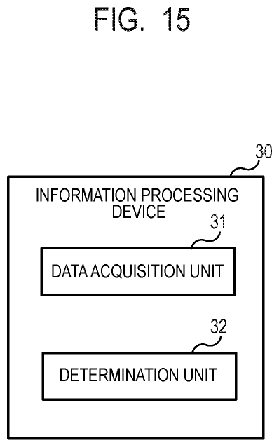

An information processing device 30 according to a third example embodiment of the present invention will be described with reference to FIG. 15. FIG. 15 is a block diagram illustrating a function configuration of the information processing device 30 according to the present example embodiment. The information processing device 30 has a data acquisition unit 31 and the determination unit 32. The data acquisition unit 31 acquires, from a target system, learning data used in learning of a model used for anomaly detection and inspection data to be used for inspection of the model in the target system. The determination unit 32 determines whether or not relearning of the model is required based on a deviation degree between a data distribution of the learning data and a data distribution of the inspection data. According to the information processing device 30 of the present example embodiment, it is possible to promptly detect a change in the data trend and perform relearning of a model at a suitable timing.

### Modified Example Embodiments

While the present invention has been described above with reference to the example embodiments, the present invention is not limited to the example embodiments described above. Various modifications that may be understood by those skilled in the art can be made to the configuration and details of the present invention within the scope not departing from the spirit of the present invention.

For example, the method of detecting a change in a data trend is not limited to the method illustrated as an example in the above example embodiments. Whether or not there is a change in a data trend (whether or not relearning of a model is required) may be determined in accordance with the fact that the total data quantity of a certain period (for example, one day) has increased or decreased significantly from the past total data quantity. The number of users may increase suddenly due to a merger of companies, aggregation of systems, or the like. In such a case, since users different from the previous users increase, a change in the data trend is expected.

Further, although application examples of the present invention to a mail system or a technical field of information communication have been described as examples in the above example embodiments, the present invention is also applicable to technical fields other than the field of mail systems or information communication.

For example, the present invention can be applied to data analysis of delivery histories in transportation business. It is possible to analyze the data trend of history data including delivery items, delivery destinations, types of delivery service, or the like on a user basis and perform relearning of a model at a suitable timing. As a result, the information processing device can accurately detect an abnormal delivery, an abnormal order, or the like.

Similarly, for example, the present invention can be applied to data analysis of use histories and remittance data of credit cards in retail business or financial business. It is possible to analyze the data trend of history data or remittance data of used credit cards, purchased items, or the like on a user basis and perform relearning of a model at a suitable timing. As a result, the information processing device can accurately detect abnormal use of a credit card, unauthorized use and unauthorized remittance data of a card by a third party, or the like.

Further, the scope of each of the example embodiments further includes a processing method that stores, in a storage medium, a program that causes the configuration of each of the example embodiments to operate so as to implement the function of each of the example embodiments described above, reads the program stored in the storage medium as a code, and executes the program in a computer. That is, the scope of each of the example embodiments also includes a computer readable storage medium. Further, each of the example embodiments includes not only the storage medium in which the computer program described above is stored but also the computer program itself.

As the storage medium, for example, a floppy (registered trademark) disk, a hard disk, an optical disk, a magneto-optical disk, a compact disc-read only memory (CD-ROM), a magnetic tape, a nonvolatile memory card, or a ROM can be used. Further, the scope of each of the example embodiments includes a configuration that operates on operating system (OS) to perform a process in cooperation with another software or a function of an add-in board without being limited to a configuration that performs a process by an individual program stored in the storage medium.

A service implemented by the function of each of the example embodiments described above may be provided to a user in a form of Software as a Service (SaaS).

The whole or part of the example embodiments disclosed above can be described as, but not limited to, the following supplementary notes.

### (Supplementary Note 1)

An information processing device comprising:

a data acquisition unit that acquires, from a target system, learning data used in learning of a model to be used for anomaly detection and inspection data used for inspection of the model in the target system; and

a determination unit that, based on a deviation degree between a data distribution of the learning data and a data distribution of the inspection data, determines whether or not relearning of the model is required.

### (Supplementary Note 2)

The information processing device according to supplementary note 1, wherein the learning data and the inspection data were generated in different periods, respectively.

### (Supplementary Note 3)

The information processing device according to supplementary note 2, wherein the inspection data was generated in one of the periods after the learning data was generated.

### (Supplementary Note 4)

The information processing device according to any one of supplementary notes 1 to 3 further comprising:

a clustering unit that performs clustering on the learning data; and

a cluster determination unit that, based on the model, determines a cluster to which the inspection data belongs,

wherein the determination unit compares a result of the clustering with a result of the determination to determine whether or not the relearning is required.

### (Supplementary Note 5)

The information processing device according to supplementary note 4,

wherein the determination unit includes

a first calculation unit that, based on a result of the clustering, calculates an expected frequency distribution indicating a relationship between the cluster to which the learning data belongs and a data quantity for each cluster,

a second calculation unit that, based on a result of the determination, calculates an observed frequency distribution indicating a relationship between the cluster to which the inspection data belongs and the data quantity for each cluster, and

a test unit that tests whether or not an error of the observed frequency distribution to the expected frequency distribution exceeds a predetermined significance level value.

### (Supplementary Note 6)

The information processing device according to any one of supplementary notes 1 to 3 further comprising:

a first clustering unit that performs clustering on the learning data; and

a second clustering unit that performs the clustering on the inspection data,

wherein the determination unit compares a result of the clustering on the learning data with a result of the clustering on the inspection data to determine whether or not the relearning is required.

### (Supplementary Note 7)

The information processing device according to supplementary note 6, wherein the determination unit compares the number of clusters generated by the clustering on the learning data with the number of clusters generated by the clustering on the inspection data to determine whether or not the relearning is required.

### (Supplementary Note 8)

The information processing device according to supplementary note 6, wherein the determination unit compares, among clusters generated by the clustering, centroid coordinates of clusters in a correspondence relationship between the learning data and the inspection data to determine whether or not the relearning is required.

### (Supplementary Note 9)

An information processing method comprising:

acquiring, from a target system, learning data used in learning of a model used for anomaly detection and inspection data to be used for inspection of the model in the target system; and

based on a deviation degree between a data distribution of the learning data and a data distribution of the inspection data, determining whether or not relearning of the model is required.

### (Supplementary Note 10)

A storage medium storing a program that causes a computer to perform:

acquiring, from a target system, learning data used in learning of a model used for anomaly detection and inspection data to be used for inspection of the model in the target system; and

based on a deviation degree between a data distribution of the learning data and a data distribution of the inspection data, determining whether or not relearning of the model is required.

1. An information processing device comprising:
a data acquisition unit that acquires, from a target system, learning data used in learning of a model to be used for anomaly detection and inspection data used for inspection of the model in the target system; and
a determination unit that, based on a deviation degree between a data distribution of the learning data and a data distribution of the inspection data, determines whether or not relearning of the model is required.

2. The information processing device according to claim 1, wherein the learning data and the inspection data were generated in different periods, respectively.

3. The information processing device according to claim 2, wherein the inspection data was generated in one of the periods after the learning data was generated.

4. The information processing device according to claim 1 further comprising:
a clustering unit that performs clustering on the learning data; and
a cluster determination unit that, based on the model, determines a cluster to which the inspection data belongs,
wherein the determination unit compares a result of the clustering with a result of the determination to determine whether or not the relearning is required.

5. The information processing device according to claim 4,
wherein the determination unit includes
a first calculation unit that, based on a result of the clustering, calculates an expected frequency distribution indicating a relationship between the cluster to which the learning data belongs and a data quantity for each cluster,
a second calculation unit that, based on a result of the determination, calculates an observed frequency distribution indicating a relationship between the cluster to which the inspection data belongs and the data quantity for each cluster, and
a test unit that tests whether or not an error of the observed frequency distribution to the expected frequency distribution exceeds a predetermined significance level value.

6. The information processing device according to claim 1 further comprising:
a first clustering unit that performs clustering on the learning data; and
a second clustering unit that performs the clustering on the inspection data,
wherein the determination unit compares a result of the clustering on the learning data with a result of the clustering on the inspection data to determine whether or not the relearning is required.

7. The information processing device according to claim 6, wherein the determination unit compares the number of clusters generated by the clustering on the learning data with the number of clusters generated by the clustering on the inspection data to determine whether or not the relearning is required.

8. The information processing device according to claim 6, wherein the determination unit compares, among clusters generated by the clustering, centroid coordinates of clusters in a correspondence relationship between the learning data and the inspection data to determine whether or not the relearning is required.

9. An information processing method comprising:
acquiring, from a target system, learning data used in learning of a model used for anomaly detection and inspection data to be used for inspection of the model in the target system; and
based on a deviation degree between a data distribution of the learning data and a data distribution of the inspection data, determining whether or not relearning of the model is required.

10. A non-transitory storage medium storing a program that causes a computer to perform:
acquiring, from a target system, learning data used in learning of a model used for anomaly detection and inspection data to be used for inspection of the model in the target system; and
based on a deviation degree between a data distribution of the learning data and a data distribution of the inspection data, determining whether or not relearning of the model is required.
